(19) United States
(12) Patent Application Publication
(10) Pub. No.: US 2014/0199674 A1
(43) Pub. Date: Jul. 17, 2014

(54) Combined Curriculum And Grade Book Manager With Integrated Student/Teacher Evaluation Functions Based On Adopted Standards

(71) Applicant: EMPOWERED SCHOOLS, INC., (US)

(72) Inventor: Howard Michael McMackin, Chicago, IL (US)

(73) Assignee: EMPOWERED SCHOOLS, INC., Chicago, IL (US)

(21) Appl. No.: 13/743,105

(22) Filed: Jan. 16, 2013

(51) Int. Cl. G09B 5/00

(52) U.S. Cl. CPC G09B 5/00
USPC 434/350

(57) ABSTRACT

A combined curriculum and grade book manager with integrated student/teacher evaluation functions based on adopted standards is described. A curriculum managing module is configured to provide for display a plurality of course identifiers for courses taught by a teacher and a curriculum associated with each course identifier. Each curriculum includes a plurality of activity identifiers of assessment activities (e.g. tests) for each curriculum. At least some of the activity identifiers are selectively associated with a standards-based assessment activity and adopted standard. A grade book managing module is configured to provide for display a plurality of student identifiers for each course identifier and to provide for entry and display of grades for the assessment activities for each student identifier. The grade book managing module is further configured to interface with a standards-based evaluation module to produce and provide for display standards-based student scores for the assessment activities.

### BACKGROUND

1. Field of the Technology

The present disclosure relates generally to computer-implemented techniques for use in managing curriculum and grade books for teachers as well as for evaluating students and/or teachers based on adopted standards.

2. Description of the Related Art

In the prior art, there has been a long felt need for school teachers and administrators to have access to data that measures student performance on benchmarked standards and not just grades.

It would be desirable for teachers to have access to such data to be able to measure student performance on aligned course standards and benchmarks using developmental scales for local assessments. This may include each practice activity on each benchmark step towards mastery of the standard, and each final demonstration of performance mastery.

On the other hand, it would be desirable for administrators to have access to such data to make decisions about how well individual students are developing toward mastery of standards, and how well courses, teacher teams, and individual teachers are causing increased student achievement.

Note that teachers have altogether separate needs for establishing curriculums and maintaining grade books. It would be advantageous if solutions to the other above-identified needs did not add unnecessary or redundant steps for teachers/administrators, and/or require teachers/administrators to have to interface with more than one tool to achieve desirable goals.

### BRIEF DESCRIPTION OF THE DRAWINGS

Embodiments of present disclosure will now be described by way of example with reference to attached figures, wherein:

FIG. 1 is an illustration of a communication system, which includes a server and one or more computing devices, which may be utilized for implementing the techniques of the present disclosure;

FIG. 2 is a block diagram of an example computing device of FIG. 1;

FIG. 3 is a general overview diagram 300 representing a computer-implemented curriculum and grade book manager with student and teacher evaluation functions based on adopted standards, which may hereinafter be referred to as a “manager”;

FIG. 4 is another general overview diagram 400 of the manager, where techniques directed to teacher evaluation based on standards are emphasized;

FIG. 5 is a flow diagram 500 executed by the manager for teacher setup and use of the curriculum, the grade book, and reports;

FIG. 6 is a presentation 600 provided via the manager for a teacher to select one of a plurality of courses of the teacher for performing a particular task;

FIG. 7 is a presentation 700 provided via the manager for the teacher to view variables for measuring a grade and to weigh particular categories for calculating grades;

FIG. 8 is a presentation 800 provided via the module for the teacher to view and/or edit the grade book which has traditional grades for students;

FIG. 9 is a presentation 900 provided via the module for the teacher to produce and/or view a grade book report for a given student, which includes traditional grades and standards-based performance grades (“performance”);

FIG. 10 is a presentation 1000 provided via the module for the teacher to produce, edit, and/or view a plurality of assessment activities defining the curriculum of a course of the teacher;

FIG. 11 is a flow diagram 1100 executed by by the module, the flow diagram 1100 being an extension of the flow diagram 500 of FIG. 5, for teacher editing and use of the curriculum, and for aligning particular standards to assessment activities of the curriculum;

FIG. 12 is a presentation 1200 provided via the module for the teacher to view and edit units and lessons of a particular course;

FIG. 13 is a presentation 1300 provided via the module for the teacher to view the assessment activities of a particular course, and to view and assign standards and benchmarks associated each assessment activity;

FIG. 14 is a flow diagram 1400 executed by by the module, the flow diagram 1400 being an extension of the flow diagram 500 of FIG. 5, for the teacher to edit and use the curriculum, and to share and copy assessments from the database;

FIG. 15 is a presentation 1500 provided via the module for the teacher to share and copy assessments from the database (see FIG. 14);

FIG. 16 is a presentation 1600 provided via the module for setting goals for students in meeting or exceeding each standard or benchmark, to be used for generating a teacher progress or evaluation report;

FIG. 17 is a presentation 1700 provided via the module for the teacher to produce and view a grade book report which includes student grades and performances;

FIG. 18 is a presentation 1800 provided via the module for the teacher to view student performance by assessment category and by standard and benchmark;

FIG. 19 is a flow diagram 1900 executed by by the module, the flow diagram 1900 being an extension of the flow diagram 500 of FIG. 5, for teacher viewing and editing of the grade book, which includes entering maximum points for a grade on an assessment activity and points earned by a student;

FIG. 20 is a presentation 2000 provided via the module for the teacher to view and edit the grade book (see FIG. 19);

FIG. 21 is a flow diagram 2100 executed by by the module, the flow diagram 2100 being an extension of the flow diagram 1900 of FIG. 19, for the teacher to view, enter, and/or edit scoring for students for performance on benchmarks and standards;

FIG. 22 is a presentation 2200 provided via the module the module for the teacher to view, enter, and edit the scoring for students for performance on benchmarks and standards (see FIG. 21);

FIG. 23 is a flow diagram 2300 executed by by the module, the flow diagram 2100 being substantially the same as the flow diagram 2100 of FIG. 21, for the teacher to set the scoring for performance (grading system for each assessment activity);

FIG. 24 is a flow diagram 2400 executed by by the module, for an administrator to produce teacher evaluation reports;

FIG. 25 is a presentation 2500 provided via the module the module of a teacher evaluation report;

FIG. 26 is a flow diagram 2600 executed by by the module, the flow diagram 2600 being an extension of the flow diagram 2400 of FIG. 24, for the administrator to produce an (value-added) achievement demographic report based on results of standardized tests; and

FIG. 27 is a presentation 2700 provided via the module of an achievement demographic report based on results of standardized tests.

### DETAILED DESCRIPTION OF THE PREFERRED EMBODIMENTS

A combined curriculum and grade book manager with integrated student/teacher evaluation functions based on adopted standards is described herein. A curriculum managing module is configured to provide for display a plurality of course identifiers for courses taught by a teacher and a curriculum associated with each course identifier. Each curriculum includes a plurality of activity identifiers of assessment activities (e.g. tests). At least some of the activity identifiers are selectively associated with a standards-based assessment activity and an adopted standard. A grade book managing module is configured to provide for display a plurality of student identifiers for each course identifier and to provide for entry and display of grades for the assessment activities for each student identifier. The grade book managing module is further configured to interface with a standards-based evaluation module to produce and provide for display standards-based student scores for the assessment activities. Such scores may be determined based on the entered grades, or the entered grades and performance scores. The standards-based evaluation module may be further configured to produce and provide for display a standards-based teacher evaluation based on the standards-based student scores of all, most or some of the students for any given course identifier. Access of data to/from the same one or more databases may be utilized.

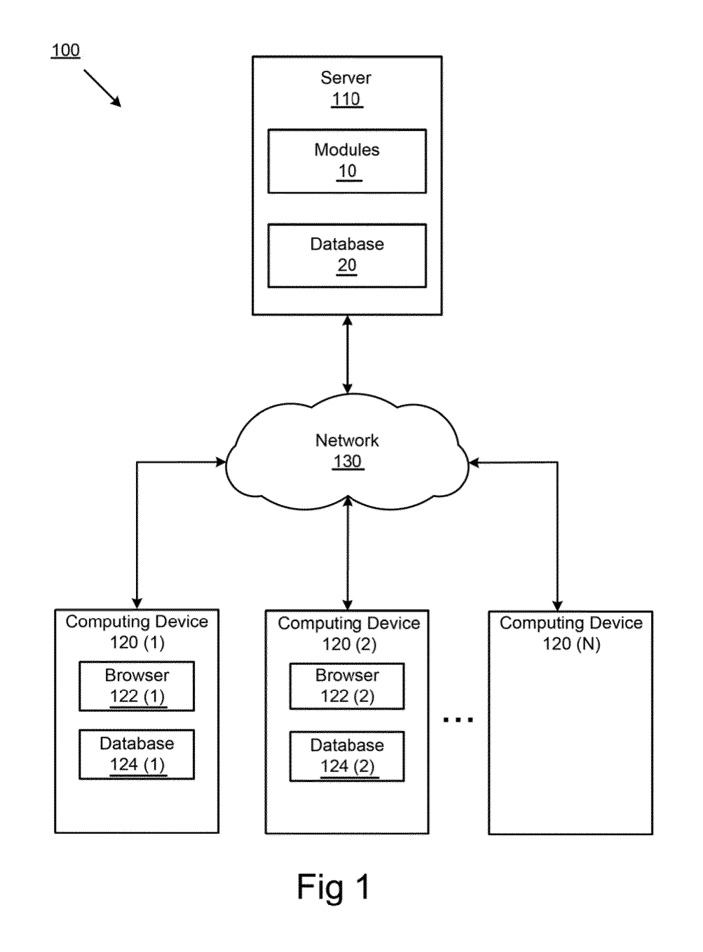

One architecture which may be utilized for techniques of the present disclosure is now shown in FIG. 1. FIG. 1 is a diagram of a system 100 which includes include a plurality of computing devices 120(1)-(N) in communication with a server 110 via a network 130. In one embodiment, server 110 includes one or more modules 10 which are programmed to perform various techniques described in relation to the drawings that follow, and a database 20 which stores the various information related to these techniques. Database 20 may be, for example, a relational database.

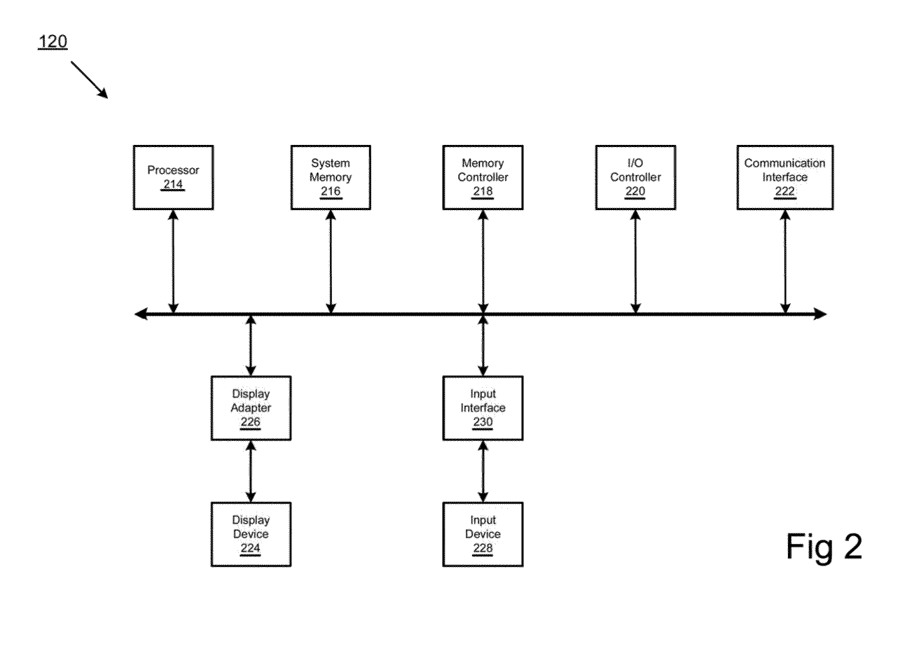

Computing devices 120(1)-(N) generally represent any type or form of computing device which interact with server 110 via network 130. Examples of computing devices 110(1)-(N) include, without limitation, laptops, desktops, servers, cellular phones, personal digital assistants (PDAs), multimedia players, terminal servers, embedded systems, combinations of one or more of the same, example computing device 120 in FIG. 2, or any other suitable computing device. Teachers and administrators would normally interface with such computing devices 120(1)-(N) for access to the functionality of the modules of server 110. Computing devices 120(1)-(N) may include a browser 122 that can be used to access some or all of the features of the server 110. Computing devices 120(1)-(N) may include databases 124(1)-(N), used for temporarily and/or permanently storing information.

Network 130 generally represents any medium or architecture capable of facilitating communication or data transfer. Examples of network 130 include, without limitation, an intranet, a wide area network (WAN), a local area network (LAN), a personal area network (PAN), the Internet, power line communications (PLC), a cellular network (e.g., a GSM Network), or the like. Network 130 may facilitate communication or data transfer using wireless or wired connections. In one embodiment, network 130 may facilitate communication between computing devices 120(1)-(N) and server 110.

In one preferred embodiment network 130 is the Internet, where computing devices 120 may access the server 110 via the Internet.

FIG. 2 is a block diagram of an example computing device 120 capable of implementing one or more of the embodiments described and/or illustrated herein. Computing device 120 broadly represents any single or multi-processor computing device or system capable of executing computer-readable instructions. Examples of computing device 120 include, without limitation, workstations, laptops, client-side terminals, servers, distributed computing systems, handheld devices, or any other device. In its most basic configuration, computing device 120 may include at least one processor 214 and a memory 216. Note that the same holds for server 110 of FIG. 1.

Processor 214 generally represents any type or form of processing unit capable of processing data or interpreting and executing instructions. In certain embodiments, processor 214 may receive instructions from a software application or module, such as a browser (e.g., web browser), to interact with the server. System memory 216 generally represents any type or form of volatile or non-volatile storage device or medium capable of storing data and/or other computer-readable instructions. Examples of system memory 216 include, without limitation, random access memory (RAM), read only memory (ROM), EEPROM, flash memory, or any other suitable memory device.

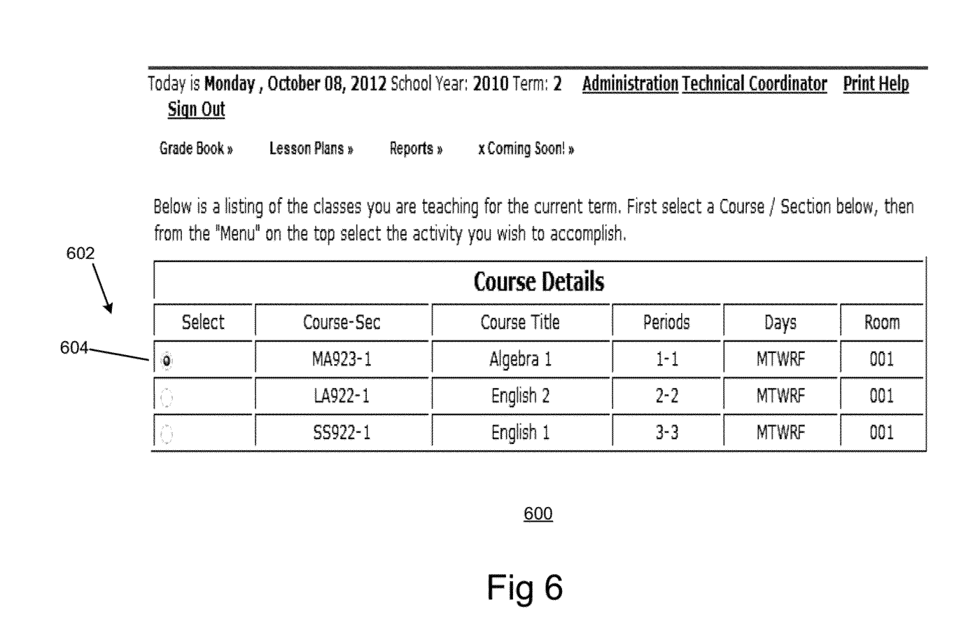

Computing device 120 of FIG. 2 may also include one or more components or elements in addition to processor 214 and memory 216. For example, as illustrated in FIG. 6, computing device 120 may include a memory controller 618, an Input/Output (I/O) controller 620, and a communication interface 122.

Memory controller 218 generally represents any type or form of device capable of handling memory or data or controlling communication between one or more components of computing device 120. For example, in certain embodiments memory controller 618 may control communication between processor 214, system memory 216, and I/O controller 220.

I/O controller 220 generally represents any type or form of module capable of coordinating and/or controlling the input and output functions of a computing device. For example, in certain embodiments I/O controller 220 may control or facilitate transfer of data between one or more elements of computing device 120, such as processor 214, system memory 216, communication interface 222, display adapter 226, and input interface 230. I/O controller 220 may also be used to perform and/or be a means for performing other steps and features set forth in the instant disclosure.

Communication interface 222 broadly represents any type or form of communication device or adapter capable of facilitating communication between example computing device 120 and one or more additional devices (e.g. server 110 of FIG. 1). Examples of communication interface 222 include, without limitation, a wired network interface (such as a network interface card), a wireless network interface (such as a wireless network interface card), a modem, and any other suitable interface. In at least one embodiment, communication interface 222 may provide a direct connection to a remote server via a direct link to a network, such as the Internet. Communication interface 122 may also indirectly provide such a connection through, for example, a local area network (such as an Ethernet network), a personal area network, a telephone or cable network, a cellular telephone connection, a satellite data connection, or any other suitable connection.

Computing device 120 also includes at least one display device 224 coupled via a display adapter 226. Display device 224 generally represents any type or form of device capable of visually displaying information forwarded by display adapter 226. Similarly, display adapter 226 generally represents any type or form of device configured to forward graphics, text, and other data for display on display device 224.

Computing device 120 also includes at least one input device 228 coupled via an input interface 230. Input device 228 generally represents any type or form of input device capable of providing input, either computer or human generated, to example computing device 120. Examples of input device 228 include, without limitation, a keyboard, a pointing device, a speech recognition device, or any other input device. Input device 228 may also be used to perform and/or be a means for performing other steps and features set forth in the instant disclosure.

The devices and subsystems referenced above may also be interconnected in different ways from that shown in FIGS. 1-2. Server 110 and computing device 120 may employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The phrase “computer-readable medium” generally refers to any form of device, carrier, or medium capable of storing or carrying computer-readable instructions. Examples of computer-readable media include, without limitation, transmission-type media, such as carrier waves, and physical media, such as magnetic-storage media (e.g., hard disk drives and floppy disks), optical-storage media (e.g., CD- or DVD-ROMs), electronic-storage media (e.g., solid-state drives and flash media), and other distribution systems.

The computer-readable medium containing the computer program may be loaded into server 110 as modules 10. All or a portion of the computer program stored on the computer-readable medium may then be stored in a system memory. When executed by a processor, the computer program may cause the processor to perform and/or be a means for performing the functions of one or more of the example embodiments described and/or illustrated herein.

Note that functionality described herein is primarily described as being executed by modules (e.g. software modules), however various terminology may be utilized, such as submodules, routines, subroutines, components, functions, functionality, etc.

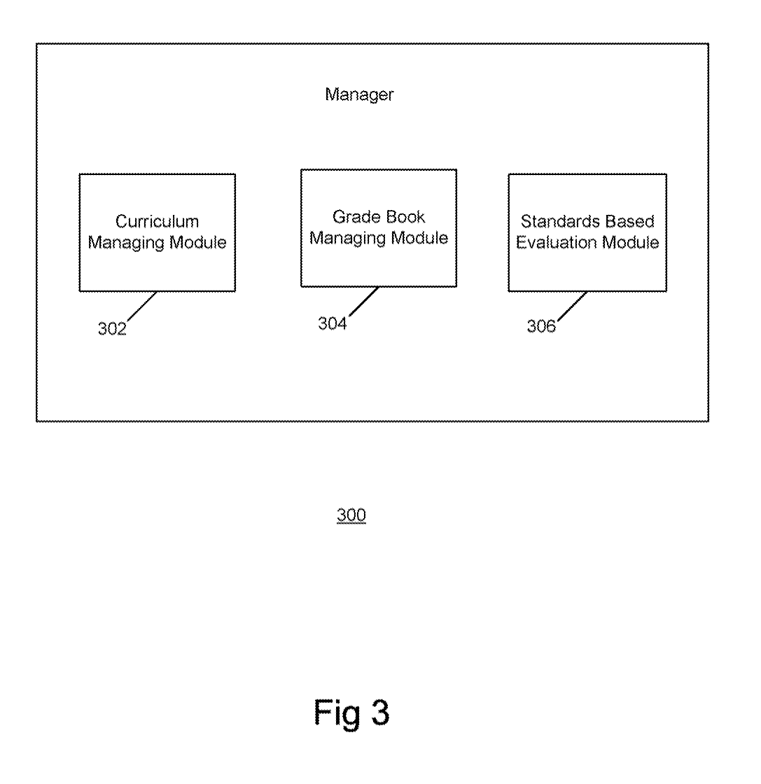

FIG. 3 is a general overview diagram 300 representing a computer-implemented, combined curriculum and grade book manager with student and teacher evaluation functions based on adopted standards (“manager”). The manager may be executed by the server 110 of FIG. 1 in association with one or more computing devices 120, where user (e.g. teacher or administrator) inputs and outputs for presentations will occur.

The manager of the present disclosure as revealed in FIG. 3 may include a curriculum managing module 302, a grade book managing module 304, and a standards-based evaluation module 306. These modules 302, 304, and 306 may access and store data to/from the same one or more databases (e.g. database 20 of FIG. 1).

Curriculum managing module 302 is configured to manage the curriculums of teachers. More particularly, curriculum managing module 302 may be configured to provide for entry, processing, and display of a plurality of course identifiers for courses taught by a teacher and a curriculum associated with each course identifier. Each curriculum may be defined by one or more unit identifiers (e.g. names) of units, one or more lesson identifiers (e.g. names) of lessons, and a plurality of activity identifiers (e.g. names) of assessment activities.

At least some of the activity identifiers are selectively associated with a standards-based assessment activity and an adopted standard. An assessment activity may be, for example, a standards-based test. The assessment activities may be copied and shared for use by multiple individuals, as shared assessments 312.

Grade book managing module 304 is configured to provide for entry, processing, and display of a plurality of student identifiers for each course identifier and grades for the assessment activities for each student identifier. Grade book managing module 304 may be configured to calculate, based on the grades for the assessment activities, a grade associated with each lesson identifier and a grade associated with each unit identifier.

Further, grade book managing module 304 is configured to interface with standards-based evaluation module 306 to produce and provide for display standards-based student scores for the assessment activities. Such scores may be determined based on the entered grades, and/or the performance scores. Reports 310, which include grade reports and standards-based performance reports, may be produced.

Standards-based evaluation module 306 may also be configured to produce and provide for display a teacher evaluation based on the standards-based student scores for all, most or some of the students for any given course identifier. For example, a percentage goal of a percentage of students to master a course may be entered or received. During or at the end of a course, a percentage of students who mastered the course may be determined. A comparison of the percentage goal with the percentage of students who mastered the course may be made and provided for in the standards-based teacher evaluation.

According to the present disclosure, student's competency level of any given standard learning objective may be determined by administering one or more shared assessment activities associated with the appropriate standard or standard learning objective. Such administration may be performed by the teacher regularly and as defined by the curriculum of the course (e.g. on a daily or weekly basis). Standard learning objectives are typically established by a rule-making body and may be applicable to one or more learning institutions. Standard learning objectives may also be known as core curriculum, core objectives, state core, national core curriculum, national standard, standard objectives, and the like. Standard learning objectives may be organized in accordance with grade level, subject matter, and the like. Standard learning objectives may be established or adopted by a rule making body at many different levels, such the national (i.e., federal) level, state level, county level, school district level, and the like.

In the techniques, separate scores may be produced for three levels of performance specification. The standard or learning goal may be scored using a custom rubric that contains developmental levels of performance quality. Each level of developmental quality within the standard (such as a benchmark or score band) may be scored separately. And the specific criteria within a benchmark or developmental level of quality may be scored separately.

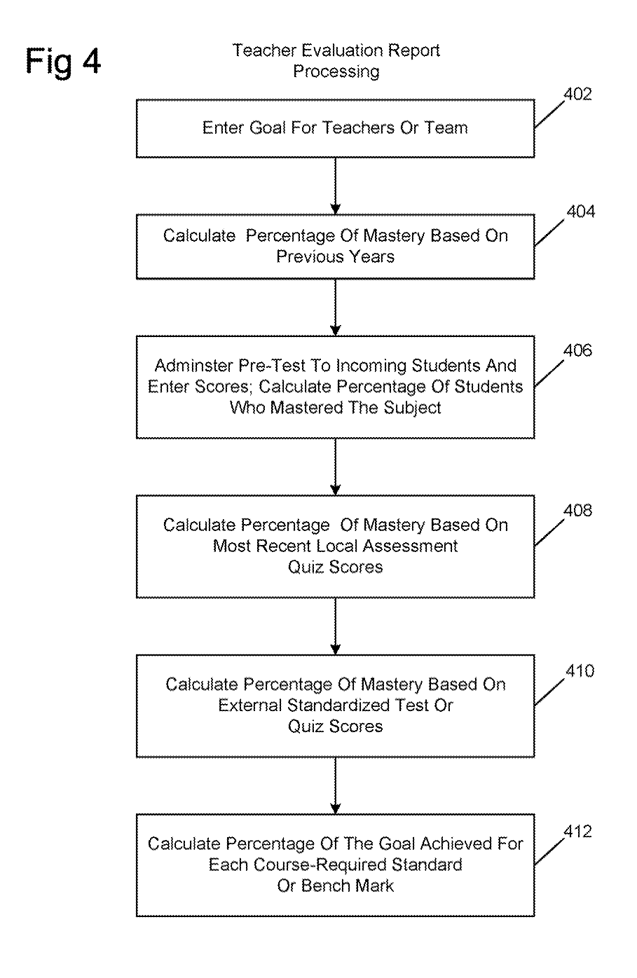

Much further detail regarding the manager of FIG. 3 is provided in relation to the description FIGS. 4-26 below.

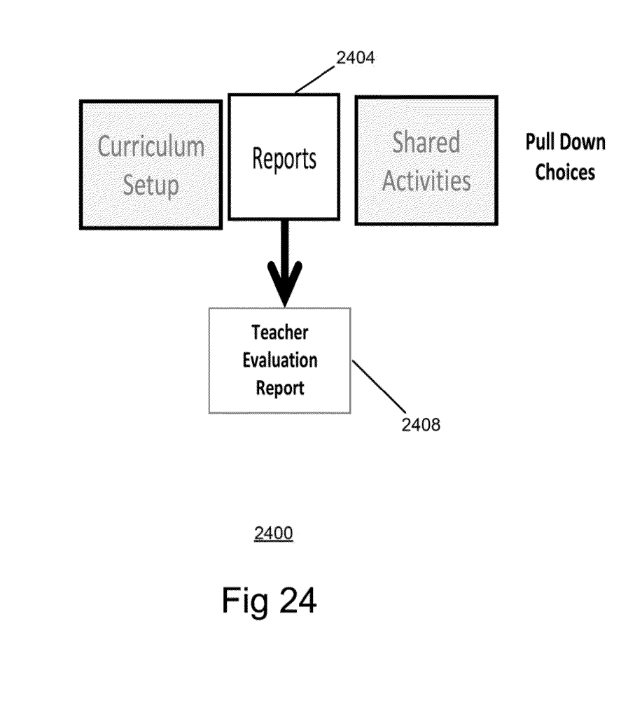

FIG. 4 is another general overview diagram 400 of the manager, where techniques directed to teacher evaluation are emphasized. Diagram 400 includes a general flow diagram 450 and a teacher evaluation flowchart 452. Diagram 450 and flowchart 452 will be described in more detail later below, for example, in relation to teacher evaluation (FIGS. 24-27).

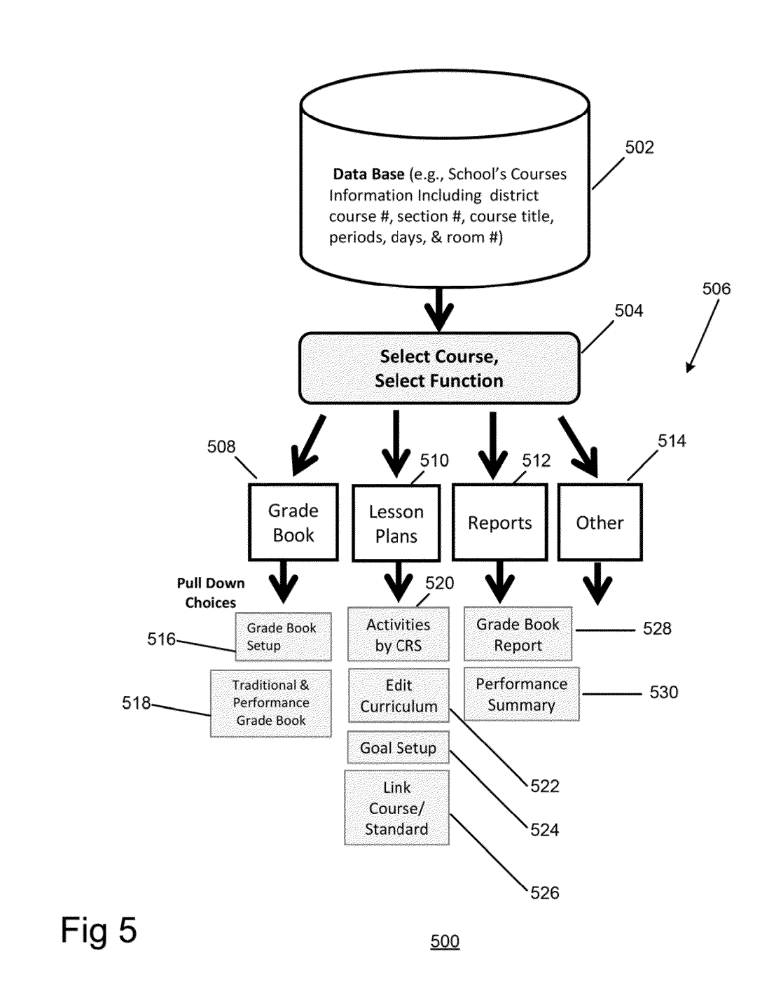

FIG. 5 is a flow diagram 500 executed by the manager, for teacher setup and use of the curriculum, the grade book, and the less plans. A database 502 (such as database 20 of FIG. 1) is utilized to store relevant data which includes course information. The course information in database 502 may include a course number (e.g. district course number) uniquely associated with a course, a section number, a course title, periods, and a room number of a room within which the course is taught.

Prior to use, the manager provides a login prompt for a teacher to logon for use of the functions and data. An authentication module configured to provide authentication for teacher access may be utilized. Upon successful authentication at the server via the login prompt, the manager causes a presentation to be displayed. This presentation includes an input prompt 504 for selecting one of a plurality of displayed courses of the teacher. For example, FIG. 6 is a presentation 600 provided via the manager for a teacher to select one of a plurality of course identifiers of the courses (such as a course identifier 604 having the course title of “Algebra 1”) taught by the teacher. In FIG. 6, course identifier 604 (name of “Algebra 1”) is shown as being selected by the teacher.

Note that the software does not require the teacher to enter course and student data. In some embodiments, the course and student data is electronically received through standard interfacing with the school's local Student Information System (SIS).

Referring back to FIG. 5, the function 504 of the manager is also for use in providing an input prompt for executing a function associated with the selected course. This input prompt may be a pull-down menu of functions which are selectable by the teacher. A plurality of modules 506 associated with these functions associated with the course include a grade book module 508, a lesson plan module 510, a report generating module 512, and other possible modules 514. Grade book module 508 includes a grade book setup module 516 and a grade book processing module 518 (for traditional and performance). Lesson plan module 510 include an activities module 520, a curriculum editing module 522, a goal setup module 524, and a course-to-standard linking module 526. Report generating module 512 includes a grade book report module 528 and a performance summary module 530.

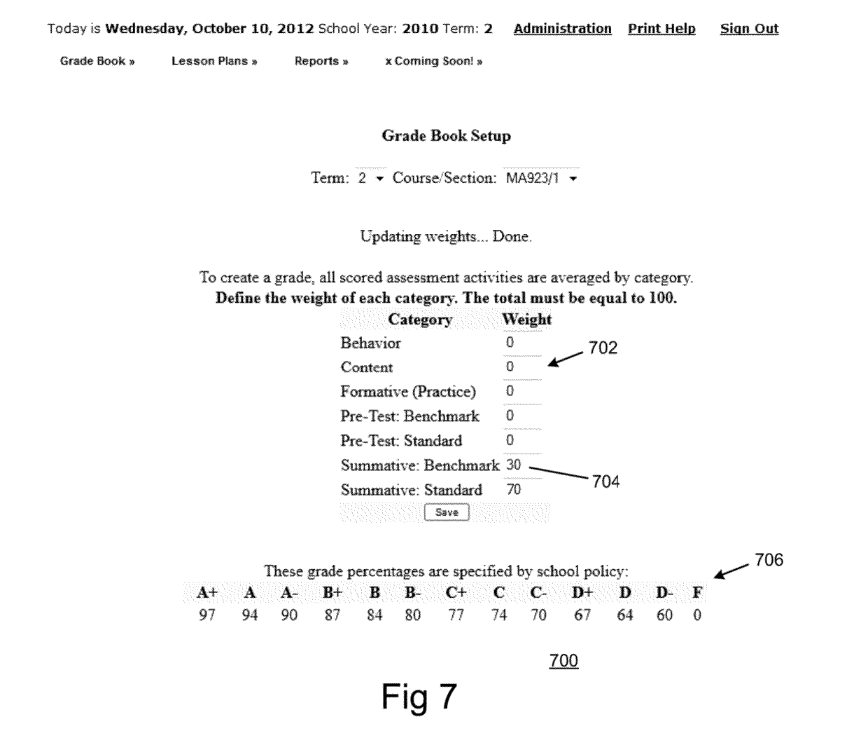

In response to the selection of the input prompt for the function for the grade book module 508, and the further selection of the function for the grade book setup module 516, the manager causes a presentation for grade book setup to be displayed. For example, FIG. 7 is a presentation 700 provided via the manager for the teacher for grade book setup. Information is presented as shown in text and the input fields in FIG. 7. Presentation 700 shows approved variables 706 for measuring a (traditional) grade, and the policy on grade percentages. Input fields 702 (such as an input field 704) for entry of weights to the categories are provided. For producing a grade, all scored assessment activities are averaged by category, where the entered weights may be applied. Note that when the total of percentages entered in, they are computed and tested to confirm that they equal to 100%. The module 516 may prompt the teacher for reentry if the total of percentages do not equal to 100%.

On the other hand in FIG. 5, in response to the selection of the function for the grade book setup module 516, the manager causes a presentation for grade book processing to be displayed. The module may provide for the presentation of an average (traditional) grade for each student in the selected course. The module may also provide for the presentation of an individual student report which includes traditional grading (e.g. grades as a percentage of 100%, or letter grades of A, B, C, D, or F). Further, the module may provide for the presentation of an individual student report for all performance scores (standards-based student scores). Even further, the module may provide for the presentation for all students of the grading and performance scores for units, lessons, and individual assessments. The module may also provide for the presentation to allow the teacher to grade, score a particular assessment, or change a score or a grade.

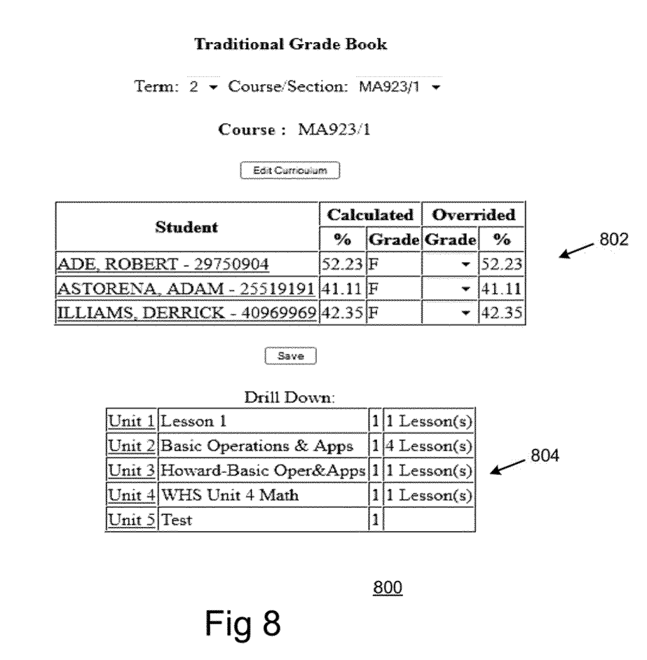

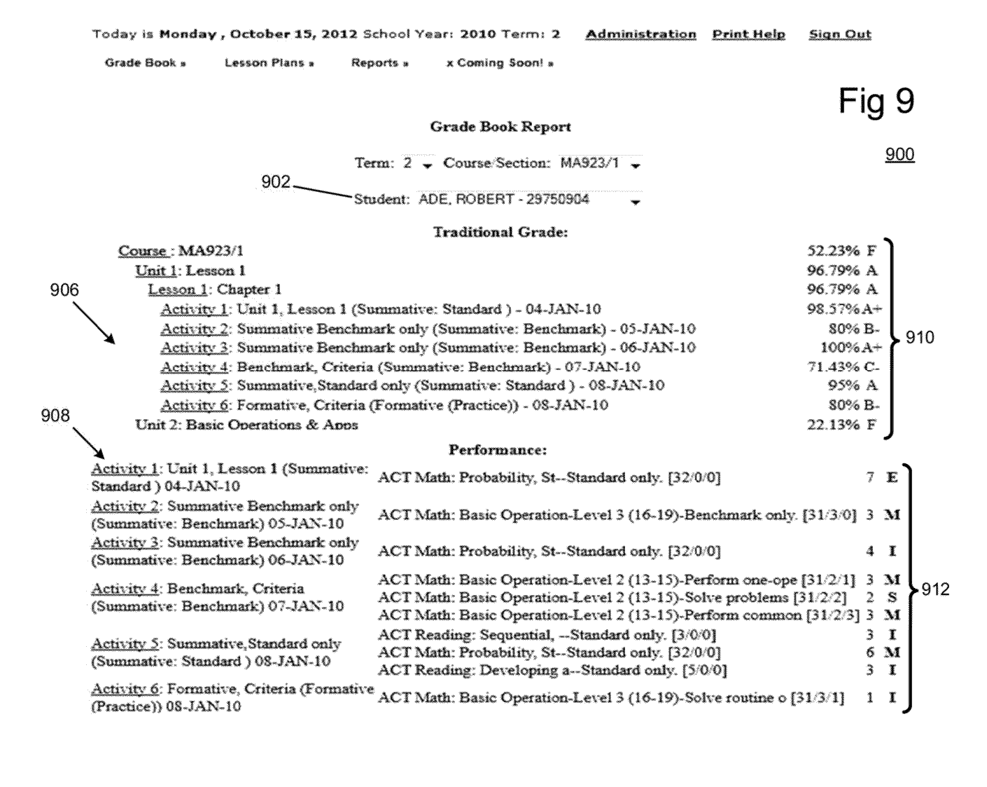

To illustrate, FIG. 8 is a presentation 800 provided via the module for the teacher for grade book processing. Information is presented as shown in text, in FIG. 8. FIG. 8 shows a traditional grade book which presents traditional grades 802 for a plurality of students of the selected course. Students are identified by student identifiers, such as student names or identification numbers. The grade book may also present a means for selecting (e.g. a pull-down menu) a particular unit and/or a lesson within each unit for the grades. To further illustrate, FIG. 9 is a presentation 900 provided via the module for the teacher to produce and/or view a grade book report for a selected individual student 902, for traditional grades 910 associated with assessment activities 906 and standards-based (“performance”) student grades 912 associated with assessment activities 908. Information is presented as shown in the text and tables in FIG. 9.

Note that the basic architecture of the present disclosure is built around the student identifier, student name, and/or student identification number—not the assessment—so that any report based on students may be produced.

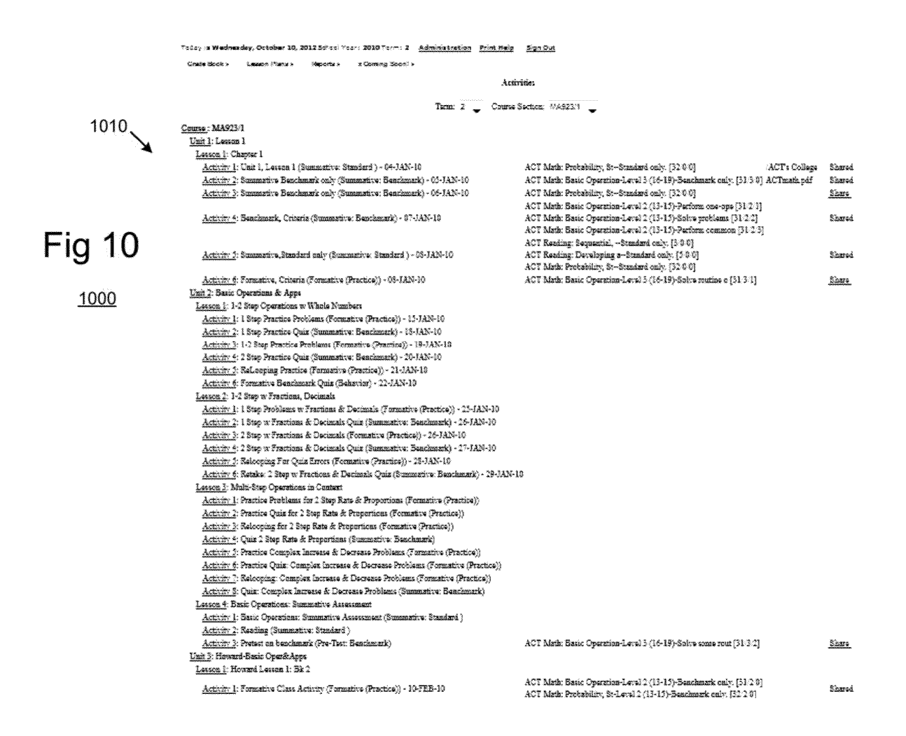

On the other hand in FIG. 5, in response to the selection of the function for lesson plan module 510, and the further selection of the function for activities module 520, the module causes a presentation for the lesson plan to be displayed. For example, FIG. 10 is a presentation 1000 provided via the module for the teacher to produce, edit, and/or view a the lesson plan associated with the course. Information is presented as shown in the text and table in FIG. 10. The module may provide for the presentation of a course curriculum which is defined by unit, lesson and/or assessment activity. As shown, assessment activities 1010 are indicated by activity identifiers, such as activity names. The module may also provide for the presentation for all students of the entered grades and performance scores of the assessment activities, and calculated grades and performance scores of lessons and units. The module may also provide for the presentation to allow the teacher to grade, score a particular assessment, or change a score or a grade.

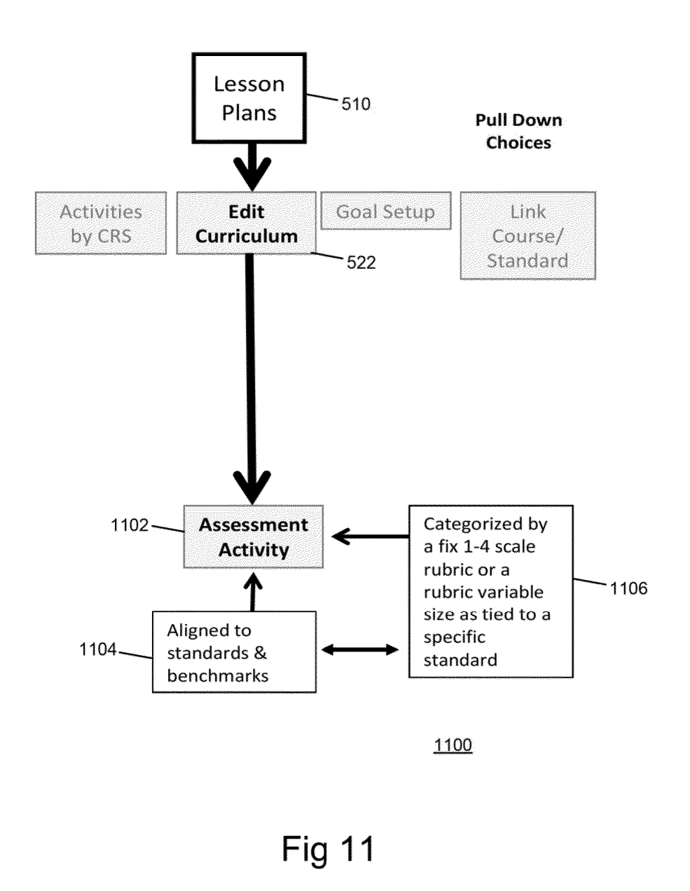

FIG. 11 is a flow diagram 1100 executed by the manager, the flow diagram 1100 being an extension of the flow diagram 500 of FIG. 5, for the teacher to align standards and benchmarks to assessment activities (also referred to as assessments) of a course. An aligner module 1104 is utilized by the teacher to align standard and benchmarks to assessment activities 1102. Also, a categorizer module 1106 is utilized by the teacher to categorize each assessment activity 1102 into one of a plurality of assessment categories. The assessment categories may be associated with different scoring systems.

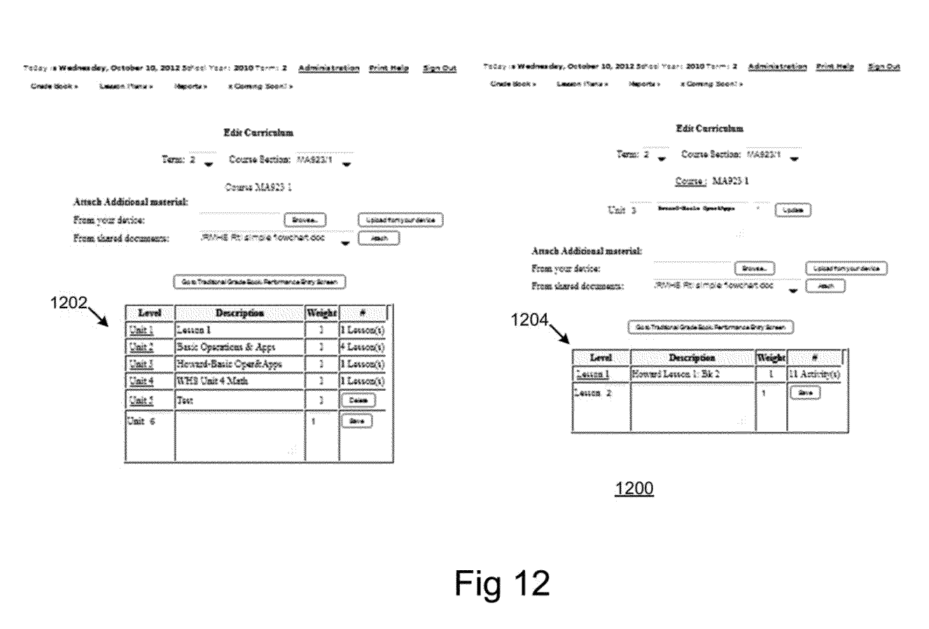

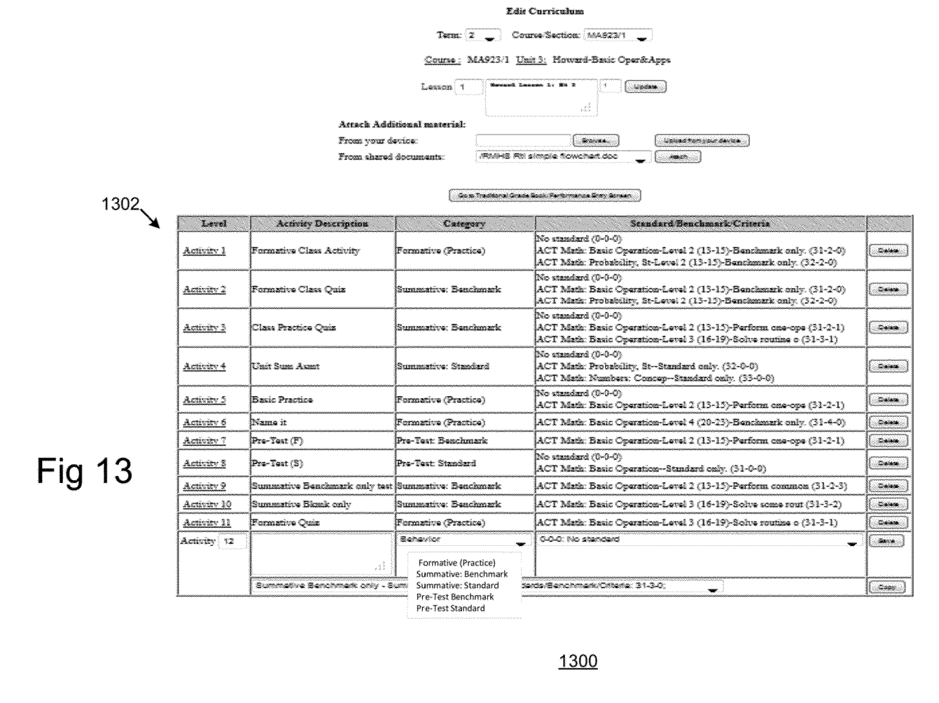

To better illustrate, FIGS. 12-13 are presentations 1200 and 1300 provided via the manager for the teacher to align standards and benchmarks with assessment activities and/or to categorize the activities into assessment categories as described. Information is presented as shown in the text and tables in FIGS. 12-13. The module may provide for presentation by unit 1202 (FIG. 12), presentation by lesson 1204 (FIG. 12), and/or presentation by assessment activity 1302 (FIG. 13).

The presentation by assessment activity 1302 in FIG. 13 reveals that each assessment activity 1302 may be selectably assigned with one of a plurality of standards and benchmarks. The presentation by assessment activity 1302 in FIG. 13 also reveals that each assessment activity 1302 may be selectably categorized into one of a plurality of assessment categories. The assessment categories may include (1) formative (practice); (2) summative: benchmark; (3) summative: standard; (4) pre-text benchmark; and (5) pre-test standard. These assessment categories may be associated with different scoring systems, such as the following: (1) formative (practice)=fixed 1-4 scale; (2) summative: benchmark=fixed 1-4 scale; (3) summative: standard=variable scale as per the number of levels in the rubric that describes the rubric; (4) pre-text benchmark=fixed 1-4 scale; and (5) pre-test standard=variable scale as per the number of levels in the rubric that describes the standard.

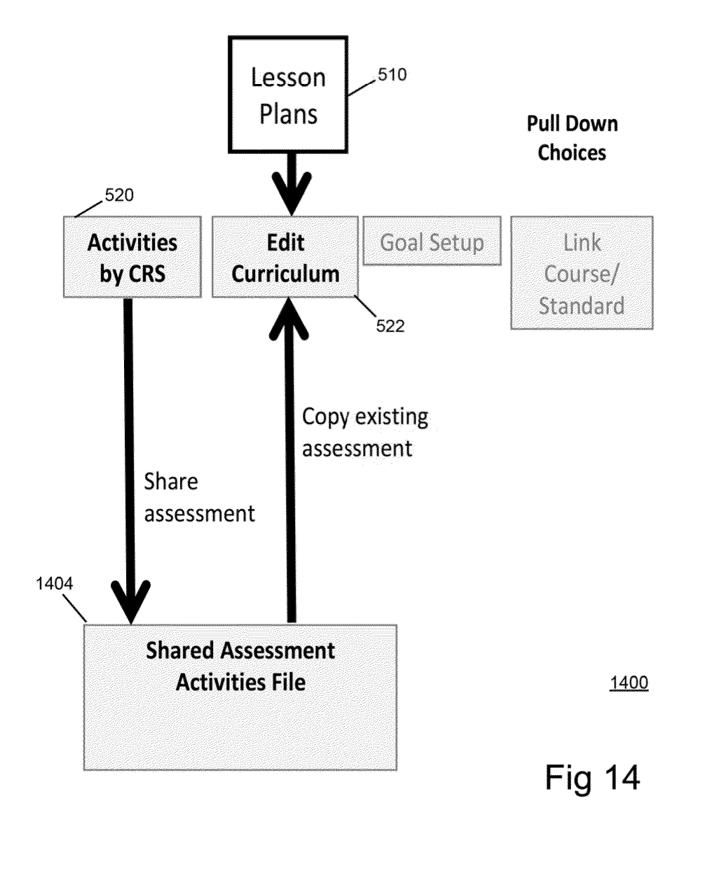

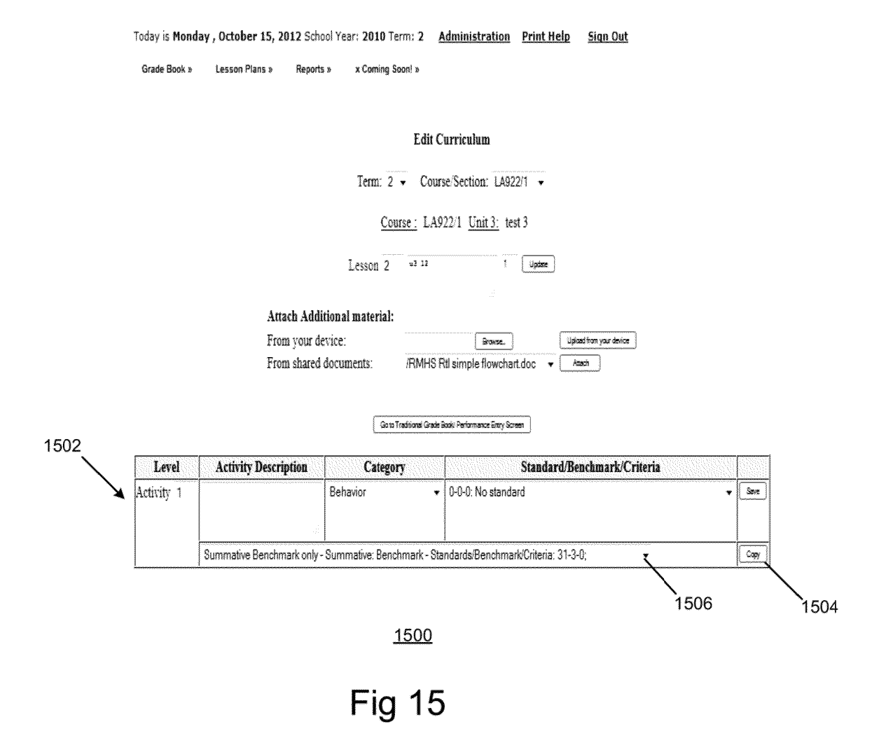

FIG. 14 is a flow diagram 1400 executed by the manager, the flow diagram 1400 being an extension of the flow diagram 500 of FIG. 5, for the teacher to share and/or copy assessment activities to/from the database. Using activities module 520, an assessment activity may be shared or stored in the database as shared assessment activities or assessments 1404. Using curriculum editing module 522, an assessment activity may be copied from shared assessment activities 1404. For example, FIG. 15 is a presentation 1500 provided via the module for the teacher to copy an assessment activity 1502 from the database. A pull-down menu 1506 may be provided for selecting one of a plurality of existing assessment activities, and an input prompt 1504 for copying the assessment activity 1502 may be invoked for copying or adding the selected assessment activity to the curriculum.

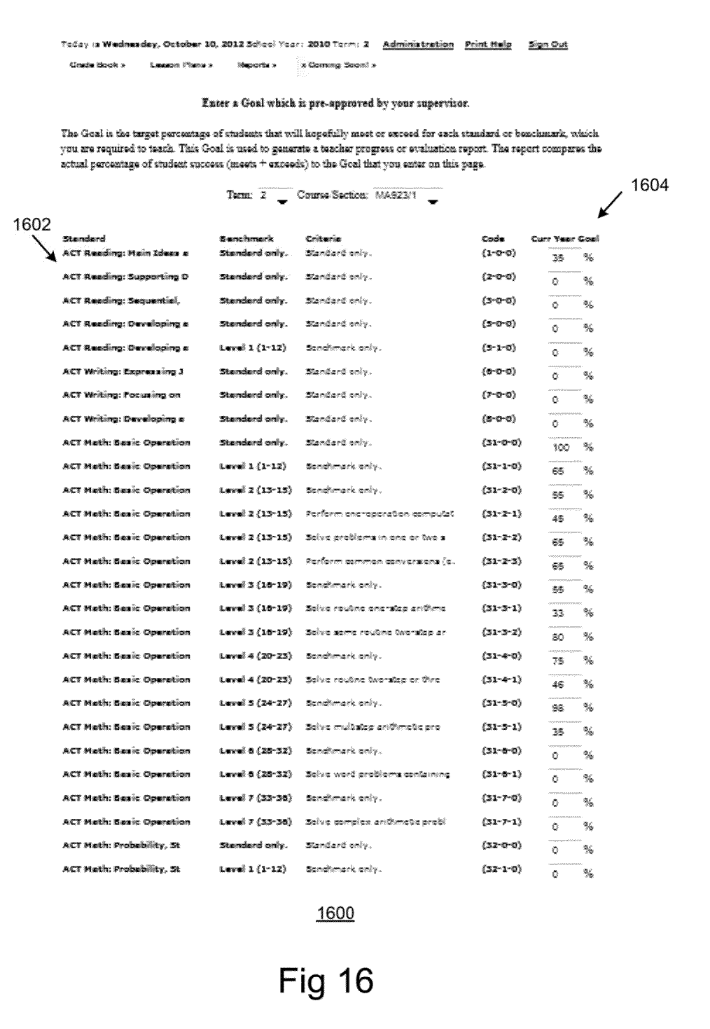

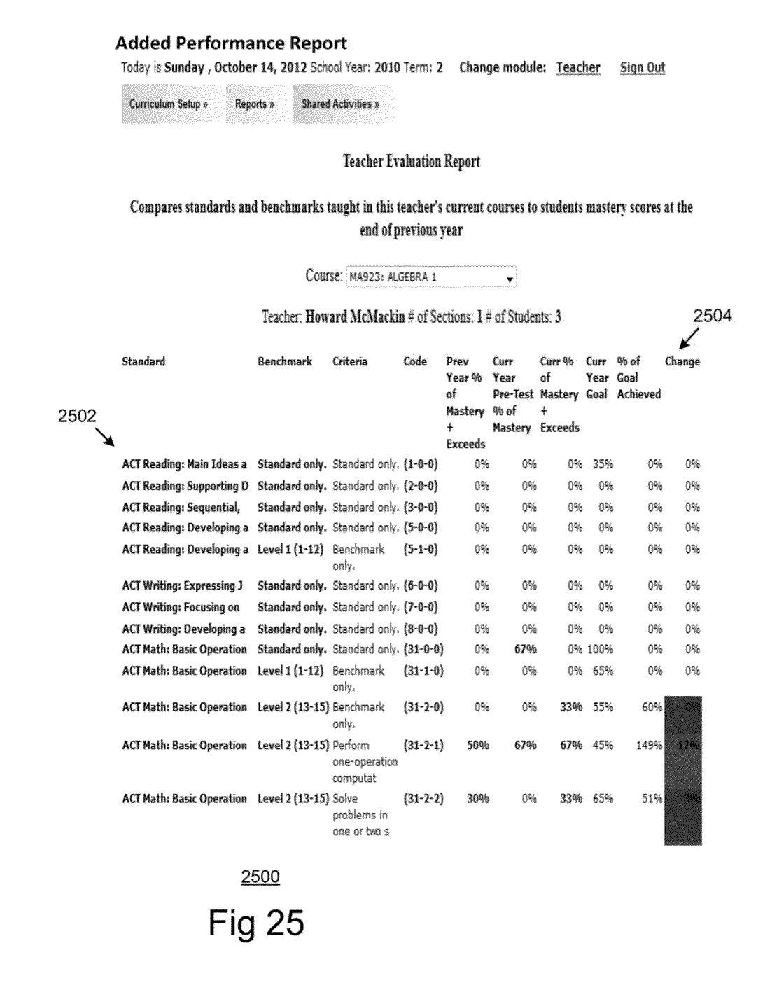

Referring back to FIG. 5, in response to the selection of the input prompt for the function for the lesson plan module 510, and the further selection of the function for the goal setup module 524, the module causes a presentation for goal setup to be displayed. For example, FIG. 16 is a presentation 1600 provided via the module for the teacher to set goals for students to meet or exceed for each standard or benchmark. These criteria are utilized for generating a teacher progress or evaluation report (see later FIGS. 24-25). Information is presented as shown in the text and input fields in FIG. 16. A plurality of standards and benchmarks 1602 are listed and, for each standard and benchmark, an input field 1604 for setting a goal is provided. The goal may be set as a percentage of students that should master each standard or benchmark in the course or course section.

On the other hand in FIG. 5, in response to the selection of the function for lesson plan module 510, and the further selection of the function for course-to-standard linking module 526, the module causes a presentation for linking (setting) a course to one of a plurality of different standards or benchmarks. By linking the course to a selected standard or benchmark, the teacher controls which standards or benchmarks may be viewable and selectable on the pull-down menu for execution of curriculum editing module 522.

On the other hand in FIG. 5, in response to the selection of the function for report generating module 512, and the further selection of the function for grade book report module 528, the manager causes a presentation for producing and/or displaying a grade book report. One or both of two different grade book reports may be produced and displayed: (1) a grade report, and (2) a performance report.

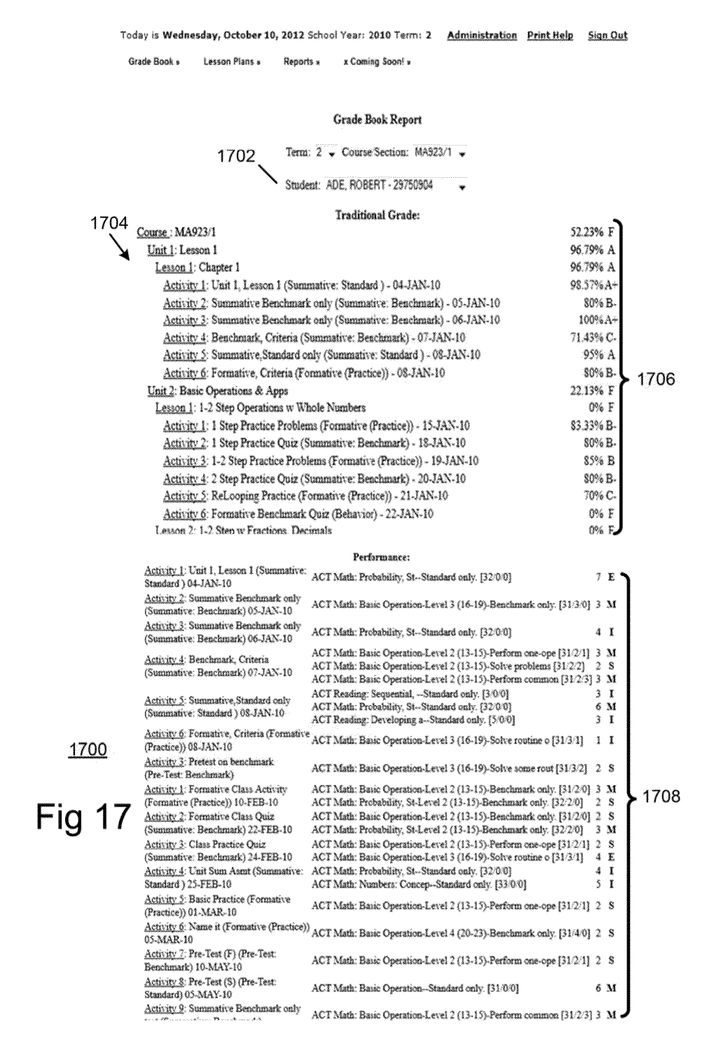

A grade report may include a student grade for each assessment activity, a grade average for each unit (calculated by the software), and a grade average for each lesson (calculated by the software). A performance report may include a student score for each assessment activity in relation to its associated standard or benchmark. For example, FIG. 17 is a presentation 1700 provided via the module for displaying a grade book report which includes a student's grades and performance scores. A student 1702 and a course may be selected from pull-down menus. Units, lessons, and assessment activities 1704 for the course are then presented. Traditional grades 1706 for each unit, lesson, and assessment activity are presented in a first table. On the other hand, performance scores 1708 for each assessment activity are presented in a second table. Performance scores 1708 may include score indicators which are letter scores corresponding to the numeric score. These letter scores may include “M” for Mastery; “E” for Exceeds; “S” for Sufficiency; and “I” for Intervention Needed.

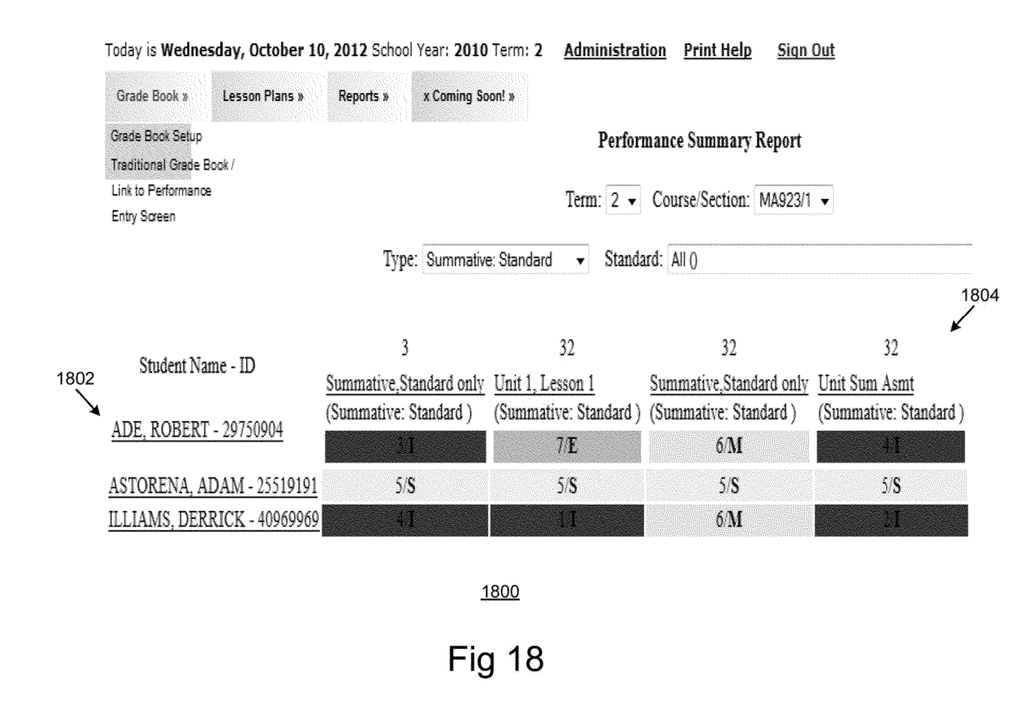

On the other hand in FIG. 5, in response to the selection of the function for report generating module 512, and the further selection of the function for performance summary module 530, the module causes a presentation for producing and/or displaying a performance summary. For example, FIG. 18 is a presentation 1800 provided via module which is a performance summary. Information is presented as shown in the text and input fields in FIG. 18. In the performance summary, the teacher may view student performance by assessment category and by standard and benchmark. A plurality of students 1802 in the selected course are listed. Students are identified by student identifiers, such as student names or numbers. A pull-down menu is provided for selecting one of a plurality of categories of assessments (e.g., summative, formative, etc.) to be included in the report. A pull-down menu is also provided for selecting one or more standards or benchmarks to be included in the report. Performance scores 1804 are then produced and displayed in response to these selections. Performance scores 1804 are color coded to correspond to the particular numeric or letter score. Color codes may be provided as follows: Light green for “M” (Mastery); Dark green for “E” (Exceeds); Yellow for “S” (Sufficiency); and Red for “I” (Intervention Needed).

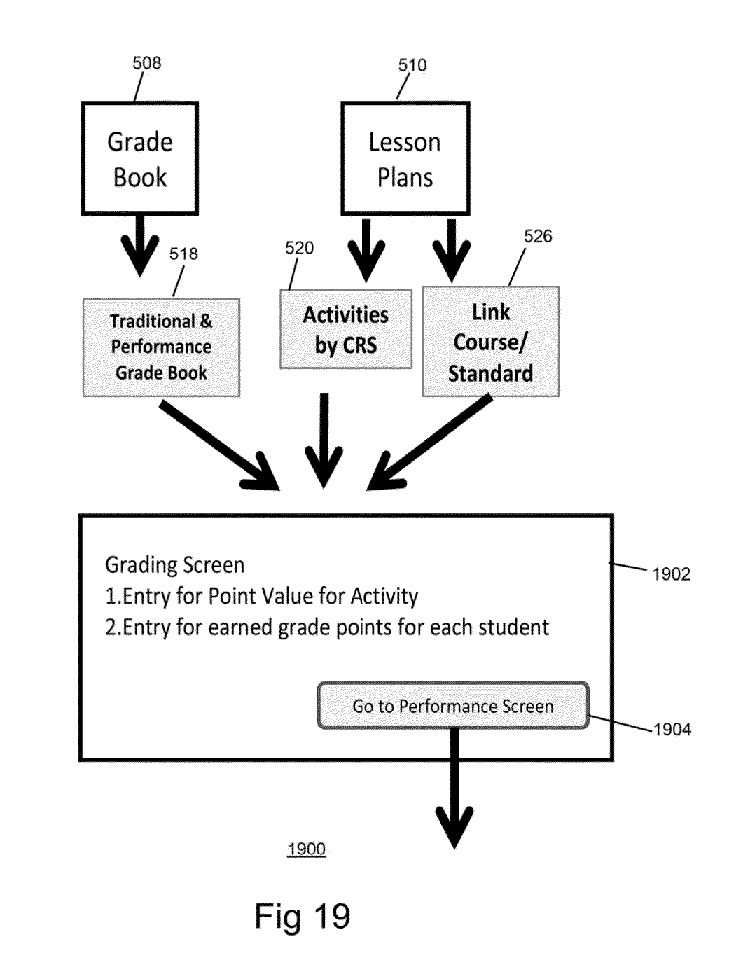

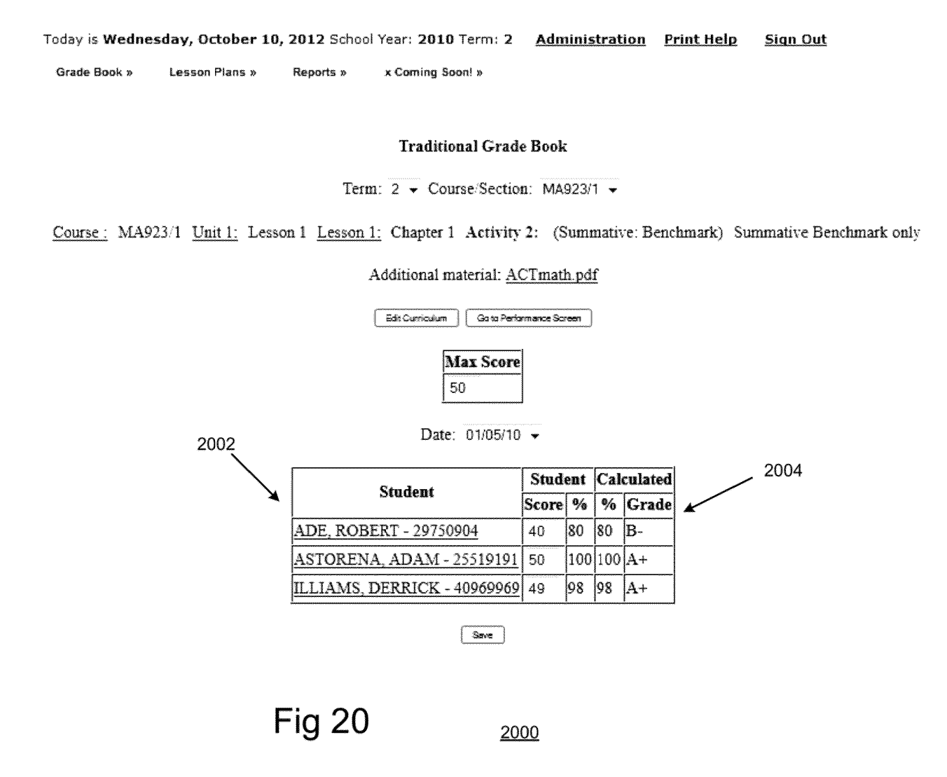

FIG. 19 is a flow diagram 1900 executed by the manager, the flow diagram 1900 being an extension of the flow diagram 500 of FIG. 5, for teacher viewing and editing of the grade book. A grading screen module 1902 provides input fields for entering maximum points for a grade on an assessment activity and points earned by a student. Grade book processing module 518 (for traditional and performance), activities module 520, and/or course-to-standard linking module 526 may be utilized to produce the grading screen. To illustrate, FIG. 20 is a presentation 2000 provided via the module for the teacher to view and edit the grade book. Information is presented as shown in the text and input fields in FIG. 20. A list of students 2002 for the selected course is provided, where students are identified by student identifiers, such as student names or numbers. Also provided is an input field for entering maximum points for a grade on an assessment activity and points earned by each student.

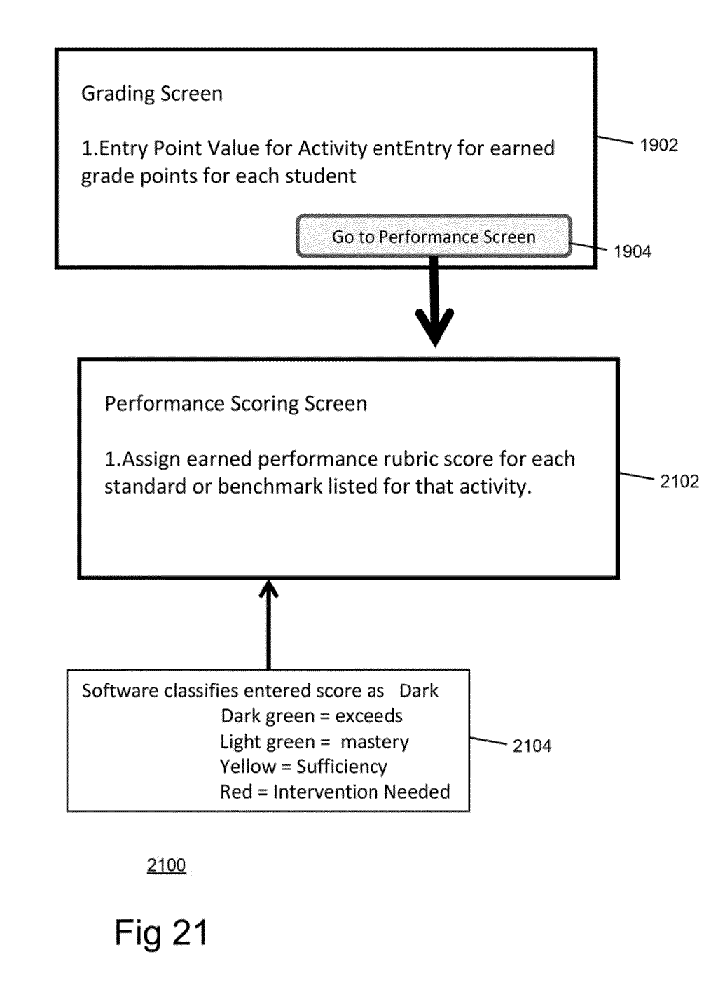

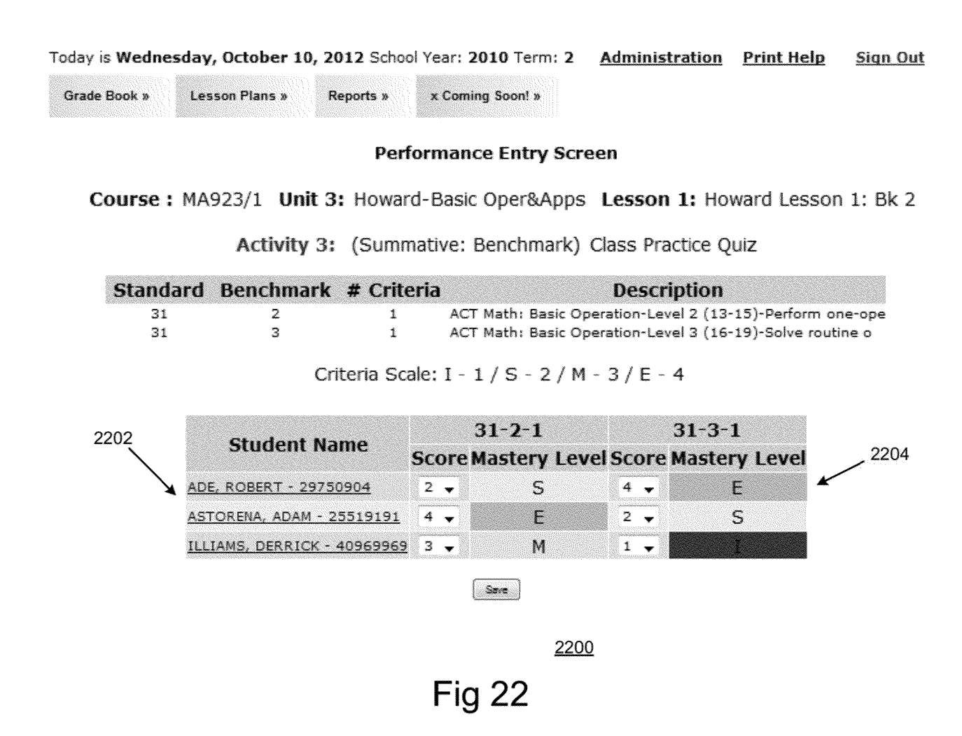

FIG. 21 is a flow diagram 2100 executed by the manager, the flow diagram 2100 being an extension of the flow diagram 1900 of FIG. 19, for the teacher to view, enter, and/or edit scoring of performance on benchmarks and standards. When the teacher selects a user prompt 1904 for executing a performance scoring screen module 2102, a presentation is generated for scoring of performance on benchmarks and standards. A rubric performance score for each standard or benchmark listed for an assessment activity may entered. For example, FIG. 22 is a presentation 2200 provided via the module the module for scoring for students for performance on benchmarks and standards. Information is presented as shown in the text and input fields in FIG. 22. Standards and benchmarks to be scored for an assessment activity are displayed, and the scoring rubric for each standard or benchmark is also displayed. In association with each student 2202 which is listed, an input field 2204 is provided for entry of a rubric performance score for each standard or benchmark. In response to entry of a rubric performance score, the score is highlighted using color codes. These may be the color codes previously described, that is, Light green for “M” (Mastery); Dark green for “E” (Exceeds); Yellow for “S” (Sufficiency); and Red for “I” (Intervention Needed).

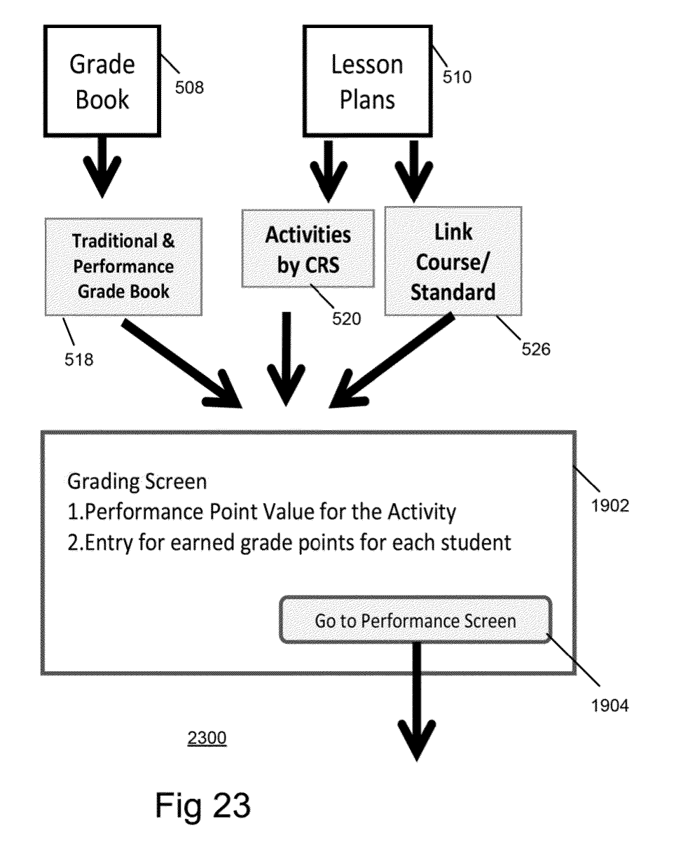

FIG. 23 is a flow diagram 2300 executed by the manager, the flow diagram 2100 being substantially the same as the flow diagram 2100 of FIG. 21, for the teacher to set the scoring for performance. The module provides multiple navigation methods for scoring performance and seeing such reports. There are two types of performance scoring systems: (1) generic 1-4 scoring; and (2) custom developmental performance rubric scoring. The generic 1-4 scoring involves a score based on a 1-4 scale (i.e. 1, 2, 3, or 4). This type may be used for formative (practice) and benchmark: summative. The custom developmental performance rubric scoring may involve a rubric of any length, and may be two or three dimensional. This type may be used as a custom scale for standard: summative.

FIG. 24 is a flow diagram 2400 executed by the manager, for an administrator to produce teacher evaluation reports. When an administrator selects an input prompt for executing a report producing module 2404 (e.g. from a pull-down menu), the administrator may further select an input prompt for executing a teacher evaluation report producing module 2408. Teacher evaluation report producing module 2408 is utilized for producing a teacher evaluation report. With reference now back to the flowchart 452 of FIG. 4, a teacher evaluation report processing technique is described for producing such a teacher evaluation report. A goal (e.g. percentage goal) for the teacher or team is entered (see e.g. description in relation to FIG. 16) (step 402 of FIG. 4). The module calculates the percentage of mastery (and above) based on the previous year, for the same standards or benchmarks aligned to the present course (step 404 of FIG. 4). The teacher administers a pre-test to incoming students and enters the scores; the module then calculates the percentage of students who have mastered the subject (and above) (step 406 of FIG. 4). The module further calculates the percentage of mastery (and above) based on the most recent local assessment scores (step 408 of FIG. 4). Further, the module calculates the percentage of mastery based on external standardized tests or quiz scores by standard and benchmark (step 410 of FIG. 4). Finally, the module calculates the percentage of the goal achieved for each course-required standard or benchmark, and may create a comparison to the previous year (step 412 of FIG. 4).

To further illustrate, FIG. 25 is a presentation 2500 which is a teacher evaluation report. Information is presented as shown in the text in FIG. 25. All standards and benchmarks 2502 aligned to the course of the teacher are provided, in association with percentages 2504 associated with students who mastered the standards and benchmarks. A percentage is provided for the previous year, for a course pre-test that was taken, and for the most current assessment. As shown, a percentage of the goal met and a percentage of increase over the previous year may also be provided.

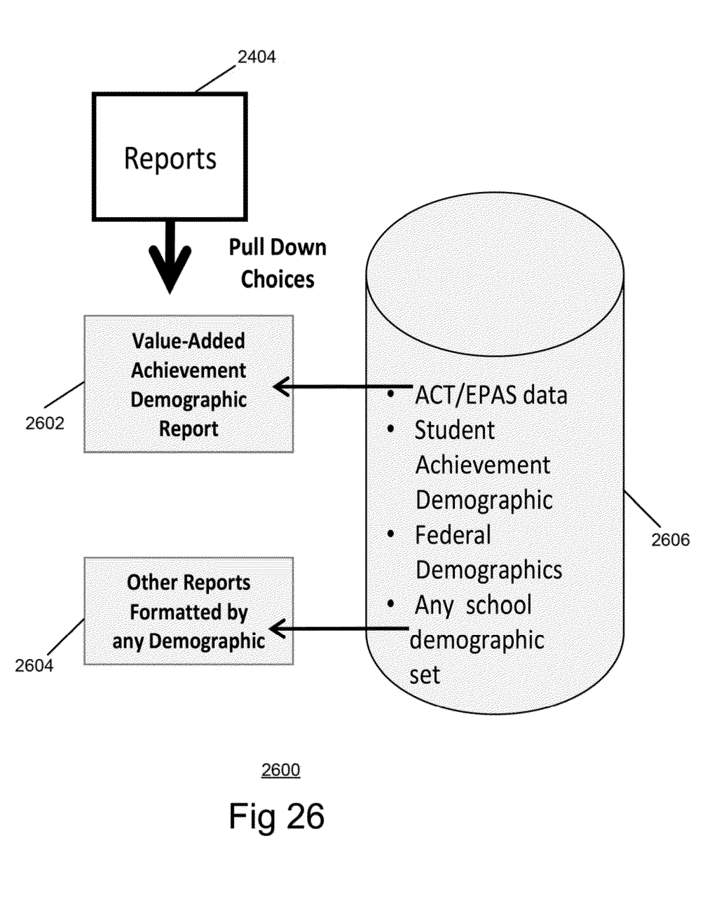

FIG. 26 is a flow diagram 2600 executed by the manager, the flow diagram 2600 being an extension of the flow diagram 2400 of FIG. 24, for the administrator to produce an (value-added) achievement demographic report based on a standardized test. When an administrator selects an input prompt for executing a report producing module 2404 (e.g. from a pull-down menu), the administrator may further select an input prompt for executing an (value-added) achievement demographic report producing module 2602. Achievement demographic report producing module 2602 is utilized for producing and displaying a (value-added) achievement demographic report using data from a database 2606 (e.g. database 20 of FIG. 1). Database 2606 may include various relevant data for this purpose, such as ACT/EPAS data, student achievement demographics, federal demographics, or any school demographic set. Other reports formatted by any demographic may be produced and displayed by one or more other demographic report producing modules 2604.

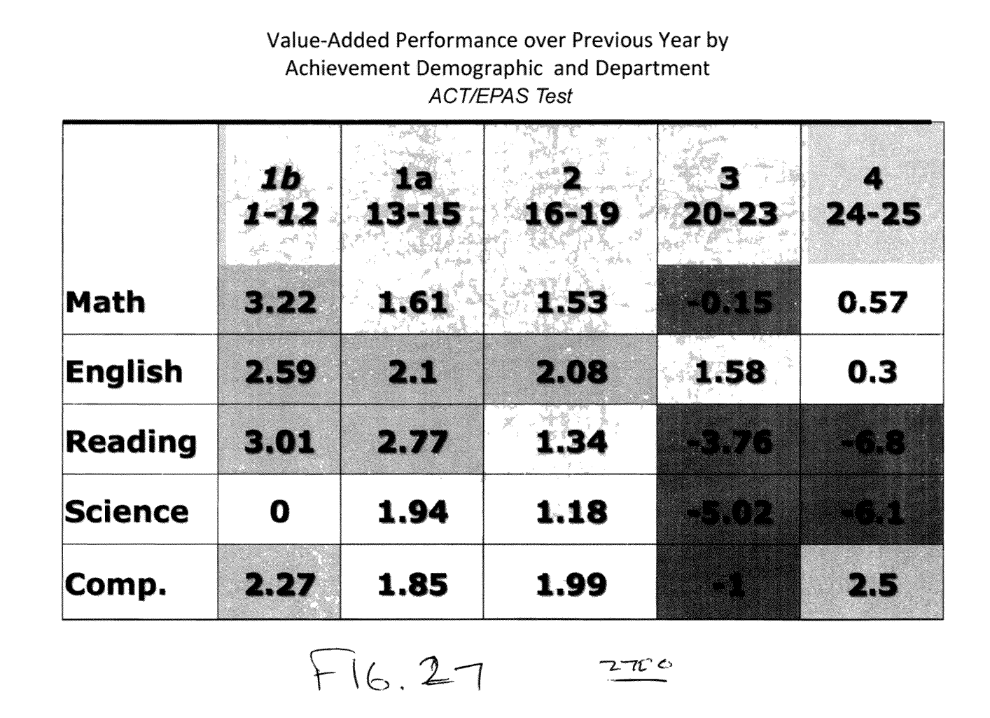

To illustrate that described in relation to FIG. 26, FIG. 27 is a presentation 2700 provided via the manager of an achievement demographic report based on the standardized test (see FIG. 26). Students are administered a standardized test (e.g. ACT Explore Test). Based on the scores on the standardized test, the students are classified into groups defined by how well each student has performed on the test. How well each group has performed on the standardized text, by department or test segment, for example, is produced and displayed. Numbers are classified and color coded using a scale that defines growth expectation. For example, 4 or greater=purple; 2-3.9=dark green; 1-2.9=light green; 0-0.9=yellow; and 0 or less=red.

As described earlier above, the operations set forth in the methods may be contained as utilities, programs, or subprograms, in any desired computer accessible medium. In addition, the methods may be embodied by computer programs, which may exist in a variety of forms both active and inactive. For example, the computer program may exist as software program(s) comprised of program instructions in source code, object code, executable code or other formats. Any of the above may be embodied on a computer readable medium. Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

Thus, a combined curriculum and grade book manager with integrated student/teacher evaluation functions based on adopted standards has been described. A curriculum managing module is configured to provide for display a plurality of course identifiers for courses taught by a teacher and a curriculum associated with each course identifier. Each curriculum includes a plurality of activity identifiers of assessment activities. At least some of the activity identifiers are selectively associated with a standards-based assessment activity and an adopted standard. A grade book managing module is configured to provide for display a plurality of student identifiers for each course identifier and to provide for entry and display of grades for the assessment activities for each student identifier. The grade book managing module is further configured to interface with a standards-based evaluation module to produce and provide for display standards-based student scores for the assessment activities. The standards-based student scores may be determined based on the grades and/or performance scores. The standards-based evaluation module is further configured to produce and provide for display a standards-based teacher evaluation based on the standards-based student scores of all, most or some of the students for any given course identifier. Access of data to/from the same one or more databases may be utilized.

On the other hand, one illustrative method of the present disclosure may involve providing a curriculum managing function for managing courses of a teacher, which includes displaying a plurality of course identifiers for the courses taught by the teacher and a curriculum associated with each course identifier, each curriculum including a plurality of activity identifiers of assessment activities, and wherein at least some of the activity identifiers are selectively associated with a standards-based assessment activity and an adopted standard; and further providing a grade book managing function for managing a grade book for the teacher, which includes providing for display of a plurality of student identifiers for each course identifier of the teacher and providing for entry and display of grades for the assessment activities for each student identifier; and even further providing a standards-based evaluation function for producing and providing for display standards-based student scores for the assessment activities.

The above-described embodiments of the present disclosure are intended to be examples only. Those of skill in the art may effect alterations, modifications and variations to the particular embodiments without departing from the scope of the application. The invention described herein in the recited claims intends to cover and embrace all suitable changes in technology.

What is claimed is:

1. A server module for use with a computing device, comprising;
a curriculum managing module, the curriculum managing module being configured to provide for display a plurality of course identifiers for courses taught by a teacher and a curriculum associated with each course identifier, each curriculum including a plurality of activity identifiers of assessment activities, and wherein at least some of the activity identifiers are selectively associated with a standards-based assessment activity and adopted standard; and
a grade book managing module, the grade book managing module being configured to provide for display a plurality of student identifiers for each course identifier and to provide for entry and display of grades for the assessment activities for each student identifier, the grade book managing module being further configured to interface with a standards-based evaluation module to produce and provide for display standards-based student scores for the assessment activities.

2. The server module of claim 1, further comprising:
the standards-based evaluation module being further configured to produce and provide for display a standards-based teacher evaluation based on the standards-based student scores of all, most, or some students for a given course identifier.

3. The server module of claim, further comprising:
the standards-based evaluation module being further configured to receive a percentage goal of a percentage of students to master a course;
the standards-based evaluation module being further configured to calculate a percentage of students who mastered the course; and
the standards-based evaluation module being further configured to produce the standards-based teacher evaluation with a comparison of the percentage goal with the percentage of students who mastered the course.

4. The server module of claim 1, wherein each curriculum is defined by one or more unit identifiers, one or more lesson identifiers, and the plurality of activity identifiers.

5. The server module of claim 1, further comprising:
wherein each curriculum is defined by one or more unit identifiers, one or more lesson identifiers, and the plurality of activity identifiers; and
wherein the grade book managing module is configured to calculate, based on the grades for the assessment activities, a grade associated with each lesson identifier and a grade associated with each unit identifier.

6. The server module of claim 1, further comprising:
an authentication module configured to provide authentication for teacher access to use of the modules with the associated courses and curriculum.

7. The server module of claim 1, which is embodied as computer instructions stored in memory of a server.

8. The server module of claim 1, which is embodied as computer instructions stored in memory of a server which is accessible via the Internet.

9. A computer-implemented method for use in managing curriculums and grade books, the method comprising:
providing a curriculum managing function for managing courses of a teacher, which includes displaying a plurality of course identifiers for the courses taught by the teacher and a curriculum associated with each course identifier, each curriculum including a plurality of activity identifiers of assessment activities, and wherein at least some of the activity identifiers are selectively associated with a standards-based assessment activity and adopted standard; and
providing a grade book managing function for managing a grade book for the teacher, which includes providing for display of a plurality of student identifiers for each course identifier of the teacher and providing for entry and display of grades for the assessment activities for each student identifier; and
providing a standards-based evaluation function for producing and providing for display standards-based student scores for the assessment activities.
